(19) United States
(12) Patent Application Publication
(10) Pub. No.: US 2026/0115843 A1
(43) Pub. Date: Apr. 30, 2026

(54) APPARATUS FOR PROCESSING WORKPIECE AND METHOD FOR ARRANGING BEAM DELIVERY SYSTEM IN PROCESSING UNIT

(71) Applicant: ORC MANUFACTURING CO., LTD., Tokyo (JP)

(72) Inventors: Masahiko FUNAYAMA, Tokyo (JP); Shuichi SHIMIZU, Tokyo (JP); Hiroyuki WASHIYAMA, Tokyo (JP)

(73) Assignee: ORC MANUFACTURING CO., LTD., Tokyo (JP)

(21) Appl. No.: 19/052,759

(22) Filed: Feb. 13, 2025

(30) Foreign Application Priority Data
Oct. 30, 2024 (JP) 2024-190607

(51) Int. Cl. B23K 37/04; B23K 26/06; B23K 26/066; B23K 37/02

(52) U.S. Cl. CPC B23K 37/04; B23K 26/0643; B23K 26/066; B23K 37/02

(57) ABSTRACT

An apparatus for processing a workpiece includes a body having a supporting structure, a beam-delivery system configured to transmit a beam from a light source to an illumination optical unit, and a vibration isolation unit configured to support the supporting structure. The supporting structure supports the illumination optical unit and a processing stage. A workpiece is mountable on the processing stage. The light source is positioned separately from the body. The beam-delivery system includes a body-side beam delivery unit supported by the supporting structure. The body-side beam delivery unit includes a correcting optical member configured to adjust an optical axis of the beam. The position of the beam-correcting optical member along a vertical direction is on or adjacent to the position of a supporting point defined in accordance to a structure of the vibration-isolation unit along the vertical direction.

### BACKGROUND OF THE INVENTION

### 1. Field of the Invention

The present invention relates to a processing unit for processing an object such as a substrate by using a beam such as a laser beam, and especially, a processing unit with a vibration-isolation unit.

### 2. Description of the Related Art

As for a substrate such as a printed wiring board, an accurately formed fine pattern is required for miniaturization of electronic equipment and high-density mounting to a semiconductor. For example, the formation of a precision via hole or groove (trench) at the micron level is required for a multilayer substrate.

Suwa et al. (US 2021/0046584Al) discloses a laser ablation (also called photoablation), which is one beam processing method. In the laser ablation, a laser beam with high energy density is used with a scanner that scans the laser beam relative to a fixed mask or reticle to project an image on a substrate or the like. By removing material from the surface of the substrate instantaneously in accordance to patterns formed on the mask or the reticle, a via hole or trench can be formed on the substrate.

A laser beam oscillated from a laser unit is directed toward an illumination optical system provided in a body, via a laser delivery system. A deviation of the optical axis occasionally occurs in the transmission path of the laser beam between the laser unit and the illumination optical system, which influences the accuracy of the processing. To correct the deviation, the laser delivery system has a beam correction mirror in the laser delivery system, in which the angle of the mirror is adjusted to match an incident position and/or angle of the laser beam to the proper position and/or angle.

When a vibration is transmitted from the surrounding area to the body during ablation processing, a projection position of the pattern to the substrate deviates from a predetermined position due to a vibration of the body, which may influence the accuracy of the processing. To prevent the vibration of the body, a vibration-isolation (also called anti-vibration) unit is provided in the body. Kimura et al. (US2015/0142182A1) discloses an active anti-vibration unit that supports a body and reduces or damps the transmitted vibration.

### SUMMARY OF THE INVENTION

The present invention is directed to a processing unit with a vibration isolation unit.

An apparatus for processing a workpiece according to the present invention includes a body having a supporting structure, a beam delivery system configured to transmit a beam from a light source to the illumination optical unit, and a vibration isolation unit configured to support the supporting structure. The supporting structure supports an illumination optical unit and a processing stage. A workpiece is mountable on the processing stage. The light source is positioned separately from the body. The beam delivery system includes a body-side beam delivery unit supported by the supporting structure. The body-side beam delivery unit includes a correcting optical member configured to adjust the optical axis of the beam. The position of the beam-correcting optical member is in a vertical direction on or adjacent to the position of a supporting point defined in accordance to the structure of the vibration isolation unit along the vertical direction.

A method for arranging a beam delivery system in a processing unit, according to another aspect of the present invention, includes: a) preparing a body having an illumination optical unit, a processing stage, a supporting structure configured to support the illumination optical unit, a floor-mounted base to support the supporting structure, and a workpiece mounted on the processing stage; b) placing a vibration-isolation unit between the bottom of the supporting structure and the floor-mounted base; c) positioning a light source separately from the body, the light source emitting a beam; d) placing a beam-delivery system between the light source and the body, the beam-delivery system transmitting a beam emitted from the light source to the illumination optical unit, the beam-delivery system including a beam-correcting optical member arranged in the body, the beam-correcting optical member configured to adjust the optical axis of the beam; and e) arranging the beam-correcting optical member at a position on or adjacent to a supporting point defined for the structure of the vibration-isolation unit, along a vertical direction.

An apparatus for processing a workpiece according to another aspect of the present invention includes a body having a supporting structure, the supporting structure supporting an illumination optical unit and a processing stage, a workpiece being mountable on the processing stage, and vibration-isolation unit configured to support the supporting structure. A supporting surface of the supporting structure that supports the processing stage is positioned below a supporting point that is defined in accordance to the structure of the vibration-isolation unit along the vertical direction.

### BRIEF DESCRIPTION OF THE DRAWINGS

The present invention will be better understood from the description of the preferred embodiment of the invention set forth below together with the accompanying drawings, in which:

FIG. 1 is a schematic plan view showing a laser processing unit according to one embodiment; and

FIG. 2 is a schematic view showing a laser delivery system.

### DESCRIPTION OF THE PREFERRED EMBODIMENTS

Hereinafter, the preferred embodiment of the present invention is described with references to the attached drawings.

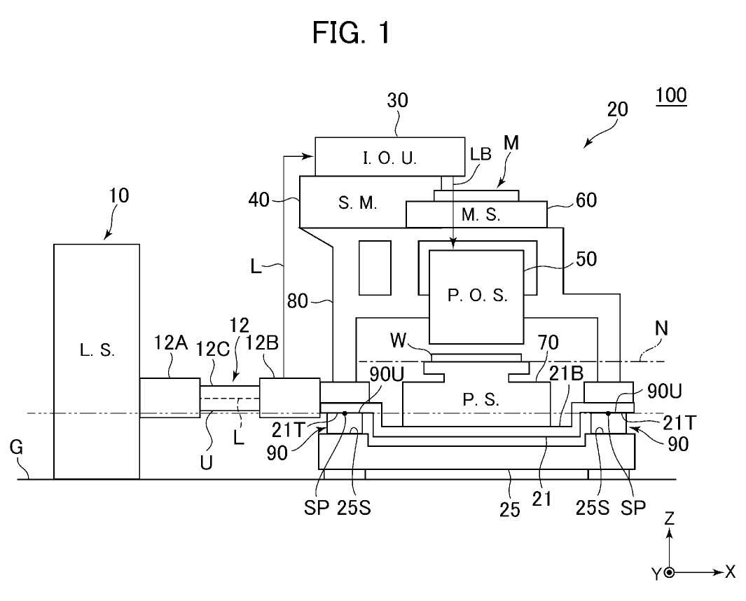

FIG. 1 is a schematic plan view showing a laser processing unit according to the present embodiment.

A laser processing unit 100 forms a pattern on a substrate W by laser ablation and is equipped with a light source 10 and a body 20. The light source 10 is a stand-alone type of light source, i.e., the light source 10 is mounted on a floor G separately from the unit body 10.

The light source 10 oscillates a laser beam with high energy density. Herein, the laser 10 is an excimer laser that emits a KrF excimer laser beam with the wavelength of 248nm. The laser beam oscillated from the light source 10 is directed toward the body 20 via a laser delivery system 12.

The body 20 is equipped with an illumination optical unit 30, a scanning mechanism 40, a projection optical system 50, a mask stage 60 and a processing stage 70, which are supported by a supporting structure 80 provided in the body 20. The frame-shaped supporting structure 80 has four legs that extend toward the floor G along the vertical direction and are evenly spaced and opposite to one another. The supporting structure 80 is mounted on the base 25 of the body 20. A mask M and the substrate W are mounted on the mask stage 60 and the processing stage 70, respectively.

The illumination optical unit 30 is equipped with a line-beam forming optical system (not shown) including a cylindrical lens, an angle switching mirror, etc. The line-beam forming optical system forms a line-shaped laser beam LB from the laser beam L that enters the illumination optical unit 30 along the scanning direction. The line-shaped laser beam LB is directed toward the mask M via a mirror (not shown).

The illumination optical unit 30 is supported by a framework (not shown) and arranged such that the optical axis of the line-beam forming optical system is parallel to the scanning direction. The scanning mechanism 40 supports the framework and is positioned at the height of the mask stage 60 adjacent to the mask stage 60 along the scanning direction. Herein, the X axis and Y axis are defined along the main scanning direction and the sub-scanning direction, respectively. Also, the Z axis is defined along the vertical direction.

The scanning mechanism 40 moves the illumination optical unit 30 along the scanning direction (the X-axis direction) at a given speed. Accordingly, the line-shaped laser beam LB perpendicular to the scanning direction (perpendicular to the X-axis direction) moves relative to the mask M along the scanning direction (the X-axis direction). Thus, the mask M mounted on the mask stage 60 and the substrate W mounted on the processing stage 70 are scanned, respectively.

The mask stage 60, which supports the mask M, may move the mask M along the X-axis and Y-axis directions and rotate the mask M around the Z-axis direction to position the mask M in a given position. The projection optical system 50, which has focus points on the surfaces of the mask M and the substrate W, projects a beam passing through the mask M to the substrate W as a light pattern. Herein, the projection optical system 50 is a reduced-lens optical system, which has a projection magnification less than 1 (e.g., 0.25).

The processing stage 70 functions as a wafer chuck to fix the substrate W to the processing stage 70 by vacuum suction. Also, the processing stage 70 moves the substrate W along the X-axis and the Y-axis directions and rotates around the Z-axis direction to position the substrate W to the mask M. Furthermore, the processing stage 70 may move step by step along the X-axis direction to apply an ablation process to the entire substrate W.

In the substrate W, a copper wiring layer is formed on an epoxy resin and an insulation layer is further formed on the copper wiring layer. As described above, the laser light source 10 emits the excimer laser beam with high energy density towards the substrate W, which ablates, i.e., removes material from the substrate W so that a pattern corresponding to a mask pattern (hereinafter, “processed pattern”) is formed on the substrate W.

As for a processed pattern, a through hole, blind via hole, wiring groove (trench), etc., can be formed on the substrate W. After the laser ablation process for the substrate W is finished, the substrate W is filled with a conductor such as copper.

The laser processing unit 100 has a controller (not shown in FIG. 1) that controls an ablation process. When an input operation for ablation process is carried out by an operator, the controller controls the light source 10 and the scanning mechanism 40 to scan the line-shaped laser beam LB along the X-axis direction. Furthermore, the controller controls the movement of the mask stage 60 and the processing stage 70.

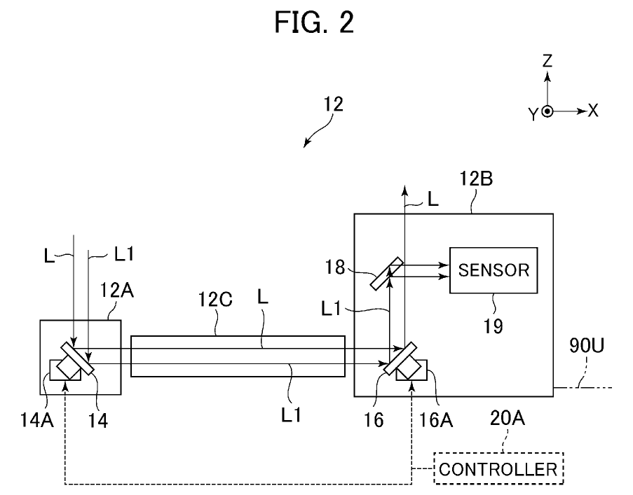

FIG. 2 is a schematic view showing the beam delivery system 12.

The beam delivery system 12 is equipped with a light-source-side beam delivery unit 12A and a body-side beam delivery unit 12B with a pipe 12C intervening between the light-source-side beam delivery unit 12A and the body-side beam delivery unit 12B. The beam delivery system 12 has a beam-position correcting mechanism (also called a beam steering mechanism) to adjust the position of the laser beam L in real time. Concretely speaking, a first adjustment mirror 14 and a second adjustment mirror 16 are provided in the light-source-side beam delivery unit 12A and the body-side beam delivery unit 12B, respectively. The first and second adjustment mirrors, 14 and 16, may shift in two axes perpendicular to one another.

In the light-source-side beam delivery unit 12A, the laser beam L is reflected off the first adjustment mirror 14 and enters the body-side beam delivery unit 12B while passing through the pipe 12C. The second adjustment mirror 16 reflects the transmitted laser beam L towards the illumination optical unit 30 (herein, the vertical direction).

In addition to the laser beam L, the light source 10 oscillates a guide laser beam L1 along an optical path parallel to the optical axis of the laser beam L for processing the substrate W. The guide laser beam L1 is reflected off the first adjustment mirror 14 and the second adjustment mirror 16, in order, and separates into two laser beams along two optical paths by the beam splitter 18. Both the separated laser beams enter the sensor 19.

The sensor 19 may detect an incident position and angle of the guide laser beam L1. Herein, the sensor 19 is a PSD (Position-Sensitive Detector). The controller 20A in the body 20 corrects the optical axis of the beam delivery system 12 by feedback control. Concretely, the controller 20A controls a first actuator 14A for the first adjustment mirror 14 and a second actuator 16B for the second adjustment mirror 16 to adjust the positions of the first and second adjustment mirrors, 14 and 16, based on the output signals from the sensor 19. Note that the controller 20A may adjust only the position of the second adjustment mirror 16.

The vibration-isolation unit 90 is arranged between the supporting structure 80 and the base 25 mounted on the floor G, and reduces or suppresses external vibrations that are transmitted to the body 20. Herein, four vibration-isolation units 90 are mounted on the base 25 opposite to the four legs of the supporting structure 80. Note that FIG. 2 shows only two vibration-isolation units 90. The vibration-isolation unit 90 is herein a passive type of vibration-isolation unit, which has an air spring. Note that an active vibration-isolation unit may be applied to the body 20 instead of the passive type of vibration-isolation unit.

The supporting structure 80 has a stage-supporting segment 21 that supports the processing stage 70 and a stage actuator (not shown) that moves the processing stage 70. As shown in FIG. 1, the stage-supporting segment 21 has a concave cross-section along the scanning direction (the X-axis direction). The position of the supporting surface 21B of the stage-supporting segment 21 is lower in the vertical direction (the Z-axis direction) than the position of a contact surface 21T that makes contact with the vibration-isolation unit 90.

During laser processing, vibrations that occur in a running machine or device adjacent to the laser processing unit 100 are transmitted to the laser processing unit 100. The vibration-isolation unit 90 works or functions to reduce or suppress the transmission of the vibrations to the supporting structure 80. The vibration-isolation unit 90 supports the supporting structure 80 around a supporting point SP.

In this context, the term “supporting point” can be defined as an imaginary central supporting position like a fulcrum when the vibration-isolation unit 90 stabilizes the supporting structure by keeping it stationary. The position of the supporting point along the vertical direction depends upon the structure of the vibration-isolation unit 90 (e.g., the position of the air spring). A supporting surface U, which includes the supporting point SP, is the upper surface (end surface) 90U of the vibration-isolation unit 90. In FIG. 1, the supporting surface U is on the upper surface 90U of the vibration-isolation unit 90.

The body-side delivery unit 12B is arranged adjacent to the bottom of the supporting structure 80, i.e., the stage-supporting segment 21. Furthermore, the second adjustment mirror 16 is arranged adjacent to the supporting point SP defined in accordance to the structure of the vibration-isolation unit 90. In other words, the position of the optical axis of the laser beam L between the first adjustment mirror 14 and the second adjustment mirror 16 is on or adjacent to the supporting surface U in the vertical direction.

The position of the second adjustment mirror 16 along the vertical direction, i.e., the position of the optical axis of the laser beam L passing through the pipe 12C is nearer to the upper surface 90U of the vibration-isolation unit 90 than either the supporting surface N of the substrate W, the mounting surface 25S of the base 25, the supporting surface 21B of stage-supporting segment 21, or the surface of the projection optical system 50.

The second adjustment mirror 16 is closest to the upper surface 90U along the vertical direction. Such a distance from the second adjustment mirror 16 to the upper surface 90U along the vertical direction may be an admission that the second adjustment mirror 16 is adjacent to the supporting point SP (supporting surface U) along the vertical direction. Herein, the position of the optical axis of the laser beam L passing through the pipe 12C is above the supporting surface U and below the supporting surface N of the processing stage 70.

Furthermore, when the distance from the second adjustment mirror 16 to the supporting point SP along the vertical direction is relatively small compared to the height of the entire body 20, e.g., the height of the body 20 is 3m and the vertical distance between the second adjustment mirror 16 and the supporting point SP is within 150mm, the position of the second adjustment mirror 16 may be defined as a position adjacent to the supporting point SP (supporting surface U).

The illumination optical unit 30, the scanning mechanism 40, the projection optical system 50, the mask stage 60, the processing stage 70 and the body-side beam delivery unit 12B are unified by the supporting structure 80. When the vibration-isolation unit 90 operates to reduce or damp a vibration, the supporting structure 80 supported by the vibration-isolation unit 90 fluctuates and the second adjustment mirror 16 varies with the fluctuation of the vibration-isolation unit 90.

Furthermore, when the illumination optical unit 30 is moved along the scanning direction by the scanning mechanism 40, a variation in the center of gravity of the body 20 occurs. The variation in the center of gravity also occurs with a movement of either the mask stage 60 or the processing stage 70. When the variation in the center of gravity is large, the position of the second adjustment mirror 16 varies with the variation in the center of gravity. The first adjustment mirror 14 also varies with the variation in the second adjustment mirror 16.

As described above, the first and second adjustment mirrors, 14 and 16, are positioned by feed-back control so that the laser beam L enters the illumination optical unit 30 accurately. However, when the variations in the first and second adjustment mirrors, 14 and 16, increase, a following accuracy of the two mirrors 14 and 16 degrades, which makes it difficult to adjust the position of the optical axis of the laser beam L.

However, since the second adjustment mirror 16 is arranged adjacent to the starting point of the position variation, i.e., supporting point SP, the position deviation of the second adjustment mirror 16 is suppressed, and the position deviation of the first adjustment mirror 14 in the light-source-side beam delivery unit 12A is also suppressed. Consequently, the adjustment of the optical axis using the first and second adjustment mirrors, 14 and 16, can be carried out precisely.

The structure of the body 20 can be separated into the upper-side segment and the lower-side segment, since the vibration-isolation unit 90 is arranged between the base 25 and the supporting structure 80. Thus, the second adjustment mirror 16 can be arranged adjacent to the bottom of the supporting structure 80, and the distance between the illumination optical unit 30 and the body-side beam delivery unit 12B along the vertical direction can be maintained as a relatively short distance.

Furthermore, the supporting surface 21B of the stage-supporting segment 21 is below the supporting surface U so that the processing stage 70 is arranged at a position closer to the floor G. Consequently, a low center of gravity of the body 20 is achieved and the position or posture of the body 20 is allowed to be stable during a laser processing.

As described above, the laser processing unit 100 according to the present embodiment is equipped with the laser delivery unit 12 that transmits the laser beam L between the light source 10 and the body 20. The beam delivery unit 12 has the second adjustment mirror 16 for adjusting the optical axis of the laser beam L. As a result, the position of the second adjustment mirror 16 along the vertical direction is arranged on or adjacent to the upper surface 90U of the vibration isolation unit 90, i.e., the supporting point SP on the supporting surface U. The supporting point SP (supporting surface U) is defined in accordance to the structure of the vibration-isolation unit 90.

Considering that the supporting surface 21B of the stage-supporting segment 21 is below the supporting surface U (the upper surface 90U), the lower center of gravity of the body 20 may suppress the influence of a vibration regardless of the position of the second adjustment mirror 16. The stage-supporting segment 21 described above enables an effective adjustment of the optical axis of the laser beam L.

Another beam-delivery system other than the above beam-delivery system 12 may be applied to the laser processing unit 100. Furthermore, another processing unit using a beam other than a laser beam may be applied.

Finally, it will be understood by those skilled in the arts that the foregoing description is of preferred embodiments of the device, and that various changes and modifications may be made to the present invention without departing from the spirit and scope thereof.

The present disclosure relates to subject matter contained in Japanese Patent Application No. 2024-190607 (filed on October 30, 2024), which is expressly incorporated herein by reference, in its entirety.

1. An apparatus for processing a workpiece, comprising:
a body comprising a supporting structure, said supporting structure supporting an illumination optical unit and a processing stage, a workpiece being mountable on said processing stage;
a beam delivery system configured to transmit a beam from a light source to said illumination optical unit, said light source being placed separately from said body; and
a vibration-isolation unit configured to support said supporting structure,
said beam delivery system comprising a body-side beam delivery unit supported by said supporting structure, said body-side beam delivery unit comprising a correcting optical member configured to adjust an optical axis of the beam,
the position of said beam-correcting optical member along a vertical direction being on or adjacent to the position of a supporting point defined in accordance to a structure of said vibration-isolation unit along the vertical direction.

2. The apparatus according to claim 1, further comprising a base mounted on a floor surface, said vibration-isolation unit being arranged between the bottom of said supporting structure and said base to support said supporting structure.

3. The apparatus according to claim 2, wherein the position of said beam-correcting optical member along the vertical direction is lower than the position of a mounted surface of said processing stage and higher than the position of the supporting point of the structure of said vibration-isolation unit.

4. The apparatus according to claim 1, wherein said supporting structure comprises a stage-supporting segment, said stage-supporting segment supporting said processing stage and being arranged at a position lower than the position of the supporting point along the vertical direction.

5. The apparatus according to claim 1, wherein said beam-correcting optical member is a variable mirror configured to reflect the beam emitted from said light source.

6. The apparatus according to claim 1, wherein said body comprises a mask stage arranged below said illumination optical unit and a projection optical system arranged below said mask stage, said supporting structure supporting said mask stage and said projection optical system,
said illumination optical unit, said mask stage, said projection optical system and said processing stage being integrated by said supporting structure.

7. The apparatus according to claim 1, wherein said light source emits a laser beam.

8. A method for arranging a beam-delivery system in a processing unit, comprising;
a) preparing a body, said body comprising an illumination optical unit, a processing stage, a supporting structure configured to support said illumination optical unit, and a base mounted on a floor to support said supporting structure, a workpiece being mounted on said processing stage;
b) placing a vibration isolation unit between the bottom of said supporting structure and said body;
c) placing a light source separately from said body, said light source emitting a beam;
d) placing a beam-delivery system between said light source and said body, said beam-delivery system transmitting a beam emitted from said light source to said illumination optical unit, said beam-delivery system comprising a beam-correcting optical member arranged in said body, said beam-correcting optical member configured to adjust an optical axis of the beam; and
e) arranging said beam-correcting optical member at a position on or adjacent to a supporting point defined for a structure of said vibration-isolation unit, along a vertical direction.

9. An apparatus for processing a workpiece, comprising;
a body comprising a supporting structure, said supporting structure supporting an illumination optical unit and a processing stage, a workpiece being mountable on said processing stage; and
a vibration-isolation unit configured to support said supporting structure, a supporting surface of said supporting structure that supports said processing stage being below a supporting point defined in accordance to a structure of said vibration-isolation unit, along a vertical direction.
